(19) United States
(12) Patent Application Publication
(10) Pub. No.: US 2025/0156180 A1
(43) Pub. Date: May 15, 2025

(54) HARDWARE ACCELERATION CIRCUIT, DATA PROCESSING ACCELERATION METHOD, CHIP, AND ACCELERATOR

(71) Applicant: Guangzhou Xiaopeng Autopilot Technology Co., Ltd., Guangzhou (CN)

(72) Inventors: Weijun Zhang, Guangzhou (CN); Hengchang Xiong, Guangzhou (CN); Yu Hu, Guangzhou (CN); Yuanxiang Guo, Guangzhou (CN); Jiang Jiang, Guangzhou (CN); Chia-Lin Lu, Guangzhou (CN)

(21) Appl. No.: 18/389,394

(22) Filed: Nov. 14, 2023

(51) Int. Cl. G06F 9/30; G06F 9/38

(52) U.S. Cl. CPC G06F 9/3001; G06F 9/3877

(57) ABSTRACT

A hardware acceleration circuit, a data processing acceleration method, a chip, and an accelerator are provided. The circuit includes: a storage module, configured to store first and second lookup tables; a lookup table circuit, configured to output, in response to respective index values of data elements and based on the first lookup table, exponential function values corresponding to the data elements; and output, in response to an index value of an addition operation result and based on the second lookup table, a reciprocal corresponding to the addition operation result; an adder, configured to obtain the addition operation result by adding the exponential function values for the lookup table circuit; and a multiplier, configured to output a multiplication operation result of an exponential function value of an i^{th} data element and the reciprocal of the addition operation result, to obtain a Softmax function value of the i^{th} data element.

### FIELD OF THE INVENTION

This application relates to the field of artificial intelligence technologies, and in particular, to a hardware acceleration circuit, a data processing acceleration method, a chip, and an accelerator.

### BACKGROUND OF THE INVENTION

The background description provided herein is for the purpose of generally presenting the context of the present invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions.

Non-linear functions introduce non-linear characteristics into an artificial neural network, to play a very important role in learning and understanding a complex scenario by the artificial neural network. The non-linear functions include but are not limited to a Softmax (Softmax) function, a Sigmoid function, and the like.

The Softmax function used as an example is widely applied to deep learning. In a related technology, a function value of the Softmax function may be calculated through a general-purpose computing unit such as a central processing unit (CPU) or a graphics processing unit (GPU). However, in a case that a processing procedure of a neural network is executed by, for example, a hardware circuit such as a deep learning accelerator (Deep Learning Accelerator, DLA for short) or a neural network processing unit (Neural Network Processing Unit, NPU for short), if a Softmax function layer is located at a network intermediate layer of the neural network, overheads of job migration (job migration) between the DLA/NPU and the CPU/GPU are caused. As a result, a solution to determination of a non-linear function value by using the CPU/GPU is inefficient, resulting in an increase in system bandwidth and higher power consumption.

Therefore, a heretofore unaddressed need exists in the art to address the aforementioned deficiencies and inadequacies.

### SUMMARY OF THE INVENTION

To resolve or partially resolve the problem existing in the related technology, this application provides a hardware acceleration circuit, a data processing acceleration method, and an accelerator, to increase a data processing speed in a Softmax function calculation procedure and accelerate obtaining of a Softmax function value.

An aspect of this application provides a hardware acceleration circuit, including:
a storage module, configured to store a first lookup table and a second lookup table;
a lookup table circuit, configured to output, in response to respective index values of a plurality of data elements in a data set and based on the first lookup table, a plurality of exponential function values corresponding to the plurality of data elements; and output, in response to an index value of an addition operation result and based on the second lookup table, a reciprocal corresponding to the addition operation result;
an adder, configured to output the addition operation result to the lookup table circuit, where the addition operation result is a result obtained by performing an addition operation on the plurality of exponential function values; and
a multiplier, configured to output a multiplication operation result of an exponential function value of an i^{th} data element in the plurality of data elements and the reciprocal, to obtain a Softmax function value of the i^{th} data element.

In an embodiment, the exponential function value is data whose bit width is N1 bits, the addition operation result is data whose bit width is N2 bits, and an index value of the addition operation result is data whose bit width is N3 bits, where, N1 and N3 are less than N2; and
the hardware acceleration circuit further includes: a first conversion circuit, configured to convert, based on an index value conversion parameter, the addition operation result to the index value of the addition operation result.

In an embodiment, the storage module includes a static storage module;
the index value conversion parameter is stored in the static storage module; and
the index value conversion parameter is determined, by collecting statistics on Gaussian distribution data of a plurality of addition operation results of a plurality of sample data sets, according to the Gaussian distribution data.

In an embodiment, the hardware acceleration circuit further includes:
an index value conversion parameter obtaining circuit, configured to determine and output, based on the addition operation result, the index value conversion parameter, where
the first conversion circuit is configured to convert, based on the index value conversion parameter, the addition operation result to the corresponding index value; and
the outputting, by the lookup table circuit based on the second lookup table, a reciprocal corresponding to the addition operation result is specifically: outputting, based on a selected second lookup table, the reciprocal corresponding to the addition operation result, where the second lookup table is a second lookup table that corresponds to the index value conversion parameter and that is of a plurality of candidate second lookup tables.

In an embodiment, the storage module includes a static storage module, and the plurality of candidate second lookup tables are stored in the static storage module; or
the storage module includes a dynamic storage module, and the selected second lookup table is stored in the dynamic storage module.

In an embodiment, the storage module includes a first storage area and a second storage area, the first lookup table is stored in the first storage area, and the second lookup table is stored in the second storage area;
the lookup table circuit includes:
a first basic lookup table circuit unit, including a first logic circuit, a first input end group, a first control end group, and a first output end group, where the first input end group is connected to the first storage area; the first logic circuit is configured to: output, in response to an index value of the i^{th} data element in the data set input from the first control end group, a corresponding exponential function value from the first output end group;
a second basic lookup table circuit unit, including a second logic circuit, a second input end group, a second control end group, and a second output end group, where the second input end group is connected to the second storage area; the second logic circuit is configured to: output, in response to the index value of the addition operation result input from the second control end group, the corresponding reciprocal from the second output end group,
where the first basic lookup table circuit unit is N0 input and N1 output, and the second basic lookup table circuit unit is N3 input and N4 output, where a value range of N0, N1, N3, and N4 is [8, 32].

In an embodiment, the storage module includes a first storage area, configured to store the first lookup table and the second lookup table in a time-sharing manner; or the storage module includes a first storage area and a second storage area, the first lookup table is stored in the first storage area, and the second lookup table is stored in the second storage area;
the lookup table circuit includes:
a first basic lookup table circuit unit, including a first logic circuit, a first input end group, a first control end group, and a first output end group, where the first input end group is connected to the storage module, and the first logic circuit configured to: output, in response to an index value of the i^{th} data element input from the first input end group and based on the first lookup table, the exponential function value corresponding to the i^{th} data element from the first output end group in a first period of time, and output, in response to the index value of the addition operation result input from the first input end group and based on the second lookup table, the reciprocal corresponding to the addition operation result from the first output end group in a second period of time after the first period of time,
where
the first basic lookup table circuit unit is in an N0-input and N1-output status; or
the first basic lookup table circuit unit further includes a status control end group, configured to input a first status control signal in the first period of time and input a second status control signal in the second period of time, to configure the basic lookup table circuit unit into an N0-input and N1-output status in the first period of time and an N3-input and N4-output status in the second period of time, at least one of a pair of N0 and N3 and a pair of N1 and N4 is not equal.

In an embodiment, the hardware acceleration circuit further includes:
a second conversion circuit, configured to convert, based on the index value conversion parameter, the multiplication operation result from data whose bit width is N4 bits to a Softmax function value whose bit width is N5 bits, where N4 is greater than N5.

In an embodiment, the hardware acceleration circuit further includes:
a subtracter, configured to output subtraction operation results of a plurality of pieces of initial data in an initial data set and a maximum value in the plurality of pieces of initial data, to obtain the data set including the plurality of data elements; and
a third conversion unit, configured to convert the plurality of data elements to a plurality of index values corresponding to the first lookup table.

In an embodiment, the exponential function value, the addition operation result, the multiplication operation result, and the reciprocal of the addition operation result are fixed-point integers.

Another aspect of this application provides an artificial intelligence chip, including the hardware acceleration circuit described above.

Still another aspect of this application provides a data processing acceleration method, including:
obtaining, based on a first lookup table, a plurality of exponential function values corresponding to a plurality of data elements in a data set;
obtaining an addition operation result of the plurality of exponential function values;
obtaining, based on a second lookup table, a reciprocal corresponding to the addition operation result; and
obtaining a multiplication operation result of an exponential function value of an i^{th} data element in the plurality of data elements and the reciprocal corresponding to the addition operation result, to obtain a Softmax function value of the i^{th} data element.

In an embodiment, the obtaining, based on a second lookup table, a reciprocal corresponding to the addition operation result includes:
converting, based on an index value conversion parameter, the addition operation result from data whose bit width is N2 bits to an index value whose bit width is N3 bits, where N3 is less than N2; and
obtaining, based on the second lookup table and the index value of the addition operation result, the reciprocal corresponding to the addition operation result.

In an embodiment, the method further includes:
writing the index value conversion parameter into a static storage module through a compiler; and
the index value conversion parameter is determined, by collecting statistics on Gaussian distribution data of a plurality of addition operation results of a plurality of sample data sets, according to the Gaussian distribution data.

In an embodiment, the method further includes:
determining, based on the addition operation result, the index value conversion parameter; and
the obtaining, based on the second lookup table and the index value of the addition operation result, the reciprocal corresponding to the addition operation result includes:
determining a selected second lookup table corresponding to the index value conversion parameter from a plurality of candidate second lookup tables; and
obtaining, based on the selected second lookup table and the index value of the addition operation result, the reciprocal corresponding to the addition operation result.

In an embodiment, the method further includes:
writing the plurality of candidate second lookup tables into a static storage module through a compiler; and/or
loading the selected second lookup table into a dynamic storage module.

In an embodiment, before the obtaining, based on a first lookup table, a plurality of exponential function values corresponding to a plurality of data elements in a data set, the method further includes: performing a subtraction operation on a plurality of pieces of initial data in an initial data set and a maximum value in the plurality of pieces of initial data, to obtain the data set including the plurality of data elements; and/or
after the obtaining a multiplication operation result of an exponential function value of an i^{th} data element in the plurality of data elements and the reciprocal, the method further includes: converting, based on an index value conversion parameter, the multiplication operation result from data whose bit width is N4 bits to data whose bit width is N5 bits, where N4 is greater than N5.

In an embodiment, the exponential function value, the addition operation result, the multiplication operation result, and the reciprocal of the addition operation result are fixed-point integers; and
a bit width value range of the exponential function value and the reciprocal is [8, 32].

In an embodiment, the method is used for implementing a Softmax function layer of a neural network, and the neural network is configured to classify to-be-processed data, where
the to-be-processed data includes at least one of voice data, text data, and image data.

Yet another aspect of this application provides an artificial intelligence accelerator, including:
a processor; and
a memory, where executable code is stored on the memory, and the executable code, when executed by the processor, enables the processor to perform the method described above.

The technical solutions provided in this application may include the following beneficial effects:

In the technical solutions of the embodiments of this application, exponential function values of data elements and a reciprocal corresponding to an addition operation result of the exponential function values of the data elements are obtained in a table lookup manner, to avoid complex exponential operations and reciprocal operations, which can increase a data processing speed in a Softmax function calculation procedure and obtain a Softmax function value more quickly.

It should be understood that the foregoing general description and detailed description in the following are merely exemplary and interpretive, but cannot constitute a limitation to this application.

### BRIEF DESCRIPTION OF THE DRAWINGS

Through a more detailed description of exemplary implementations of this application in combination with the accompanying drawings, the above and other objectives, features and advantages of this application are more obvious. In the exemplary implementations of this application, same reference numerals generally represent same components.

FIG. 1 is a schematic structural diagram of a neural network according to an embodiment of this application;

FIG. 2 is a schematic structural diagram of a neural network for classification according to an embodiment of this application;

FIG. 3 is a structural block diagram of a hardware acceleration circuit according to an embodiment of this application;

FIG. 4 is a schematic structural diagram of a basic lookup table circuit unit according to an embodiment of this application;

FIG. 5 is a structural block diagram of a hardware acceleration circuit according to another embodiment of this application;

FIG. 6 is a structural block diagram of a hardware acceleration circuit according to another embodiment of this application;

FIG. 7 is a structural block diagram of a hardware acceleration circuit according to another embodiment of this application;

FIG. 8 is a structural block diagram of a hardware acceleration circuit according to another embodiment of this application;

FIG. 9 is a schematic flowchart of a data processing acceleration method according to an embodiment of this application;

FIG. 10 is a schematic flowchart of a data processing acceleration method according to another embodiment of this application; and

FIG. 11 is a schematic flowchart of a data processing acceleration method according to another embodiment of this application; and

FIG. 12 is a structural block diagram of an artificial intelligence accelerator according to an embodiment of this application.

### DETAILED DESCRIPTION OF THE INVENTION

The following describes in detail implementations of this application with reference to the accompanying drawings. Although the accompanying drawings show the implementations of this application, it should be understood that this application may be implemented in various manners and is not limited by the implementations described herein. On the contrary, the implementations are provided to make this application more thorough and complete, and the scope of this application can be fully conveyed to a person skilled in the art.

The terms used in this application are for the purpose of describing specific embodiments only and are not intended to limit this application. The terms “a”, “said” and “the” of singular forms used in this application and the appended claims are also intended to include plural forms, unless otherwise specified in the context clearly. It should be further understood that the term “and/or” used herein indicates and includes any or all possible combinations of one or more associated listed items.

It should be understood that although the terms such as “first,” “second,” and “third,” may be used in this application to describe various information, the information should not be limited to these terms. These terms are merely used to distinguish between information of the same type. For example, without departing from the scope of this application, first information may also be referred to as second information, and similarly, second information may also be referred to as first information. Therefore, a feature limited by “first” or “second” may explicitly or implicitly include one or more features. In the descriptions of this application, “a plurality of” means two or more, unless otherwise definitely and specifically limited.

A calculation procedure of a non-linear function possibly relates to an operation procedure of an exponential function and/or a reciprocal. For example, an operation procedure of a Softmax function may relate to operation procedures of an exponential (exp) and a reciprocal of a sum of exponentials (1/sum_of_exp). A dedicated hardware pipeline used for the Softmax function is not feasible for implementing large-scale computing power. For example, an increase in computing power results in high hardware costs.

In view of the foregoing problem, the embodiments of this application provide a data processing acceleration solution, where exponential function values of data elements and a reciprocal corresponding to an addition operation result of the exponential function values of the data elements are obtained in a table lookup manner, to avoid complex exponential operations and reciprocal operations, which can increase a processing speed of a Softmax function.

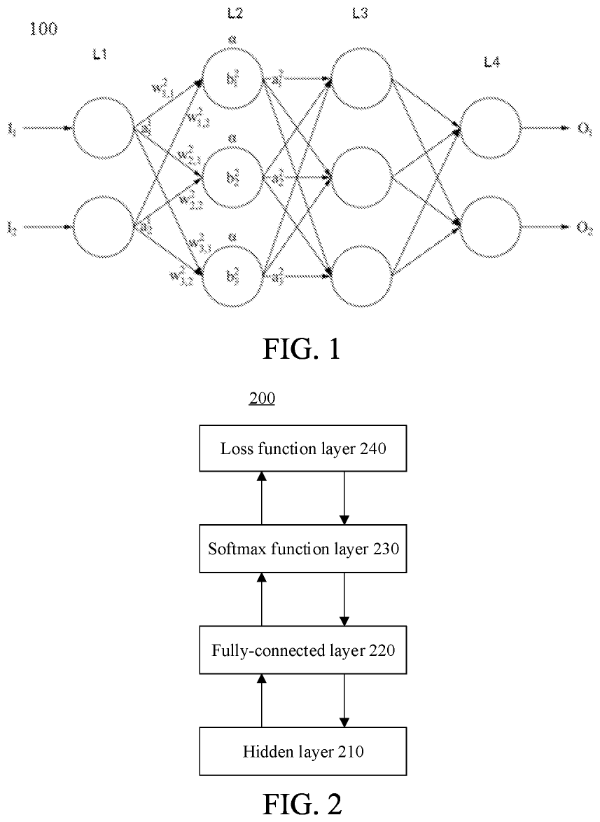

FIG. 1 is a schematic structural diagram of a neural network according to an embodiment of this application.

FIG. 1 shows a topology structure of a neural network 100, including an input layer, a hidden layer, and an output layer. The neural network 100 can execute a calculation or an operation based on data elements I₁ and I₂ received by the input layer, and generate output data O₁ and O₂ based on a result of executing the calculation.

For example, the neural network 100 may be a deep neural network (Deep Neural Networks, DNN for short) including one or more hidden layers. The neural network 100 in FIG. 1 includes an input layer L1, two hidden layers L2 and L3, and an output layer L4. The DNN includes but is not limited to a convolutional neural network (Convolutional Neural Network, CNN for short) and a recurrent neural network (Recurrent Neural Network, RNN for short).

It should be noted that the four layers shown in FIG. 1 are only intended for ease of understanding technical solutions of this application, but cannot be understood as a limitation on this application. For example, the neural network may include more or fewer hidden layers.

Nodes in different layers of the neural network 100 may be connected to each other, to perform data transmission. For example, a node may receive data from another node to execute a calculation on the received data, and output a calculation result to a node in the another layer.

Each node may determine output data of the node based on output data received from a node in a previous layer and a weight. For example, in FIG. 1, W_{1,1}² represents a weight between a first node in a first layer and a first node in a second layer. a₁¹ represents output data of the first node in the first layer. b₁² represents an offset value of the first node in the second layer, and then output data of the first node in the second layer may be represented as: a₁²=σ(W_{1,1}²×a₁¹)+b₁²). Manners of calculating output data of other nodes are similar, and details are not described herein again.

In some embodiments, an activation function layer such as a Softmax (softmax) function layer is configured in the neural network, and the Softmax function layer may convert a result value about each class to a probability value.

In some embodiments, a loss function layer is configured in the neural network after the Softmax function layer, and the loss function layer can calculate a loss as a target function for training or learning.

It may be understood that, the neural network may process, in response to to-be-processed data, the to-be-processed data, to obtain a recognition result. The to-be-processed data may include, for example, at least one of voice data, text data, and image data.

A typical type of neural network is a neural network for classification. The neural network for classification may determine a class of a data element by calculating the data element and a probability corresponding to each class.

FIG. 2 is a schematic structural diagram of a neural network for classification according to an embodiment of this application.

Referring to FIG. 2, a neural network 200 for classification of this embodiment may include a hidden layer 210, a fully-connected layer (Fully-Connected Layer, FC layer for short) 220, a Softmax function layer 230, and a loss function layer 240.

As shown in FIG. 2, the neural network 200 performs, in response to to-be-classified data, a calculation sequentially in an order of the hidden layer 210 and the FC layer 220, the FC layer 220 outputs a calculation result s, and the result corresponds to a classification probability of a data element. The FC layer 220 may include a plurality of nodes corresponding to a plurality of classes respectively, and each node outputs a result value corresponding to a probability that a data element is classified as a corresponding class. For example, referring to FIG. 1 together, the FC layer 220 corresponds to the output layer L4 in FIG. 1, and has two nodes corresponding to two classes (a first class and a second class), where an output value of one node may be a result value representing a probability that a data element is classified as the first class, and an output value of the other node may be a result value representing a probability that a data element is classified as the second class. The FC layer 220 outputs the calculation result s to the Softmax function layer 230, and the Softmax function layer 230 converts the calculation result s to a probability value y, and may further perform normalization processing on the probability value y.

The Softmax function layer 230 outputs the probability value y to the loss function layer 240, and the loss function layer 240 may calculate a cross-entropy loss (cross-entropy loss) L of the result s based on the probability value y.

In a back-propagation learning procedure, the Softmax function layer 230 calculates a gradient

$$\frac{\partial L}{\partial s}$$

of the cross-entropy loss L. Then, the FC layer 220 executes learning processing based on the gradient of the cross-entropy loss L. For example, a weight of the FC layer 220 may be updated according to a gradient descent algorithm. Further, subsequent learning processing may be executed in the hidden layer 210.

The neural network 200 may be implemented using software, or implemented using a hardware circuit, or implemented using a combination of software and hardware. For example, in a case of being implemented using a hardware circuit, the hidden layer 210, the FC layer 220, the Softmax function layer 230, and the loss function layer 240 are each implemented by a hardware circuit, and may be implemented by being integrated into an artificial intelligence chip or distributed in a plurality of chips. Through such a configuration, data migration between another layer of the neural network and a processor such as a CPU/GPU when the Softmax function layer 230 is implemented by the CPU/GPU is avoided, which can increase data processing efficiency of the neural network, reduce data processing delay and power consumption, and avoid an increase in occupied bandwidth.

The following describes in detail the technical solutions in the embodiments of this application with reference to the accompanying drawings.

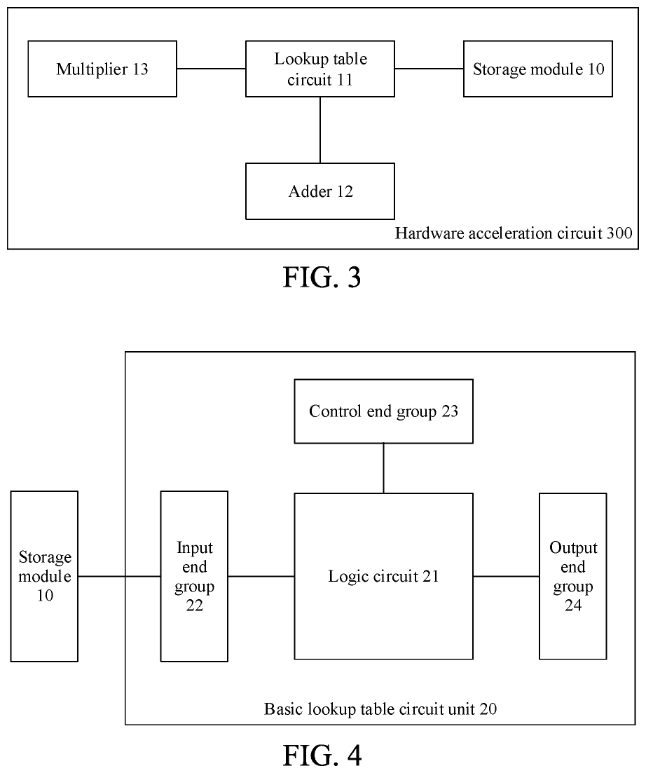

FIG. 3 is a structural block diagram of a hardware acceleration circuit according to an embodiment of this application. In this application, the hardware acceleration circuit may be, for example, configured to, but not limited to, implement the Softmax function layer 230 in the foregoing neural network 200, and the hardware acceleration circuit may be, for example, but not limited to, a circuit component in a CPLD (Complex Programmable logic device, complex programmable logic device) chip, an FPGA (Field Programmable Gate Array, field programmable gate array) chip, a dedicated chip, or the like.

For ease of understanding this application, the Softmax function is described as follows: Assuming that there is an array X, a formula of calculating a Softmax function value of an i^{th} element xᵢ may be shown as formula (1).

$${σ ( x )}_{i} = {e}^{{x}_{i}} \times \frac{1}{{\sum }_{k} {e}^{{x}_{k}}} = {e}^{( {x}_{i} - {x}_{max} )} \times \frac{1}{{\sum }_{k} {e}^{( {x}_{k} - {x}_{max} )}} \qquad formula ( 1 )$$

In the formula (1), σ(x)ᵢ represents a Softmax function value of an i^{th} element xi, e is a natural constant, xᵢ represents an i^{th} element of the array X, xₘₐₓ represents a maximum element in the array X, and

$${\sum }_{k} {e}^{{x}_{k}}$$

represents an addition operation result of exponential function values of at least some elements in the array X.

Referring to FIG. 3, a hardware acceleration circuit 300 includes a storage module 10, a lookup table circuit 11, an adder 12, and a multiplier 13.

The storage module 10 is configured to store a first lookup table and a second lookup table. The storage module 10 may be, for example, a RAM (Random Access Memory, random access memory), a ROM (Read-Only Memory, read-only memory), a FLASH, or the like.

The lookup table (Look Up Table, LUT) circuit 11 is configured to output, in response to respective index values of a plurality of data elements in a data set and based on the first lookup table, a plurality of exponential function values corresponding to the plurality of data elements; and output, in response to an index value of an addition operation result and based on the second lookup table, a reciprocal corresponding to the addition operation result.

The adder 12 is configured to output the addition operation result to the lookup table circuit 11, where the addition operation result is a result obtained by performing an addition operation on the plurality of exponential function values.

The multiplier 13 is configured to output a multiplication operation result of an exponential function value of an i^{th} data element in the plurality of data elements and the reciprocal corresponding to the addition operation result, to obtain a Softmax function value of the i^{th} data element.

In some embodiments, the lookup table circuit 11 includes at least one basic lookup table circuit unit 20.

Referring to FIG. 4, in a specific implementation, a basic lookup table circuit unit 20 includes a logic circuit 21, an input end group 22, a control end group 23, and an output end group 24. The input end group 22 connected to a storage module 10 inputs data of a lookup table to the logic circuit 21. The logic circuit 21 selects, through an index value (also referred to as an address) input from the control end group 23, a value corresponding to the index value from the lookup table, and outputs the value from the output end group 24. The logic circuit 21 may be, for example, a logic gate circuit or a logic switch circuit. It may be understood that, in this application, an end group refers to a group of connection ends, including one or more connection ends. In a case that the control end group 23 has A control ends and the output end group 24 has B output ends, the basic lookup table circuit unit 20 is referred to as A-input and B-output.

It may be understood that, an addition operation result of exponential function values may be a result obtained by performing an addition operation directly on the exponential function values, or may be a result obtained by performing an addition operation on the exponential function values on which specific transformation is performed. For a situation of performing specific transformation, corresponding inverse transformation may be performed on a subsequently obtained data processing result based on a transformation type, or inverse transformation processing is not additionally performed. Similarly, various types of processing performed on other data should also be understood as including the foregoing two situations in a broad sense, but should not be limited to only processing performed on the data itself. Other embodiments are similar, and details are not described again below.

In this embodiment, exponential function values of data elements and a reciprocal corresponding to an addition operation result of the exponential function values are obtained in a table lookup manner through a hardware lookup table circuit, to avoid complex exponential operations and reciprocal operations, which can increase a data processing speed in a Softmax function calculation procedure and obtain a Softmax function value more quickly. In another aspect, excessively large hardware circuit area and excessively high costs generated for implementing exponential operations and reciprocal operations are avoided.

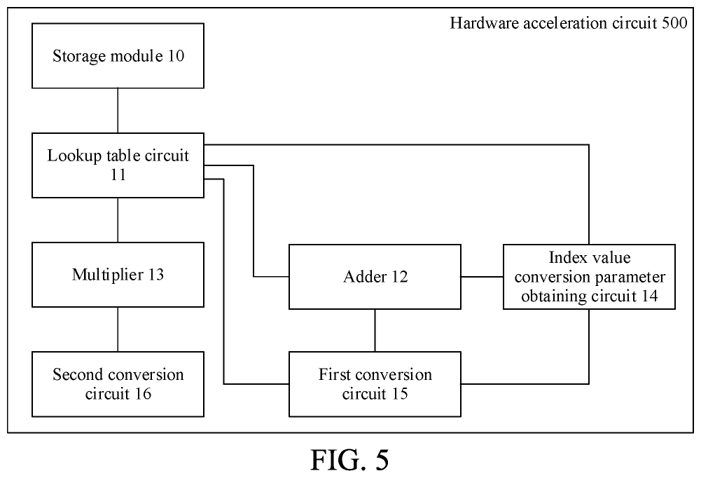

FIG. 5 is a structural block diagram of a hardware acceleration circuit according to another embodiment of this application.

Referring to FIG. 5, a hardware acceleration circuit 500 includes a storage module 10, a lookup table circuit 11, an adder 12, a multiplier 13, an index value conversion parameter obtaining circuit 14, a first conversion circuit 15, and a second conversion circuit 16.

The storage module 10 is configured to store a first lookup table and a second lookup table.

The lookup table circuit 11 is configured to output, in response to respective index values of the plurality of data elements in the data set and based on the first lookup table, the plurality of exponential function values corresponding to the plurality of data elements. An index value of a data element is data whose bit width is N0 bits.

In an embodiment, the respective index values of the plurality of data elements are sequentially input to the lookup table circuit 11, and the lookup table circuit 11 sequentially outputs the exponential function values corresponding to the data elements in the first lookup table.

Each exponential function value in the first lookup table is data whose bit width is N1 bits.

The adder 12 is configured to output the addition operation result to the lookup table circuit 11, where the addition operation result is a result obtained by performing an addition operation on the plurality of exponential function values.

In an embodiment, the adder 12 accumulates the exponential function values of the data elements, to output an addition operation result whose bit width is N2 bits.

The index value conversion parameter obtaining circuit 14 and the first conversion circuit 15 are configured to obtain an index value corresponding to the addition operation result output by the adder 12.

The index value conversion parameter obtaining circuit 14 is configured to determine and output, based on the addition operation result, the index value conversion parameter.

The first conversion circuit 15 is configured to convert, based on the index value conversion parameter, the addition operation result to the corresponding index value. The index value output by the first conversion circuit 15 is data whose bit width is N3 bits.

The lookup table circuit 11 outputs, in response to the index value of the addition operation result and based on a selected second lookup table, the reciprocal corresponding to the index value of the addition operation result, where the selected second lookup table is a second lookup table that corresponds to the index value conversion parameter and that is of a plurality of candidate second lookup tables. Each reciprocal stored in the second lookup table is data whose bit width is N4 bits. That is to say, the reciprocal of the addition operation result output by the lookup table circuit 11 is data whose bit width is N4 bits.

The multiplier 13 is configured to output a multiplication operation result of an exponential function value of an i^{th} data element in the plurality of data elements and the reciprocal of the addition operation result. The multiplication operation result output by the multiplier 13 is data whose bit width is N5 bits.

The second conversion circuit 16 is configured to convert, based on the index value conversion parameter, the multiplication operation result output by the multiplier 13 to data whose bit width is N6 bits, to output a Softmax function value of the i^{th} data element.

In a specific implementation, an index value of a data element is a fixed-point integer whose bit width is 8 bits. Each exponential function value in the first lookup table is a fixed-point integer whose bit width is 8 bits. The addition operation result of the plurality of exponential function values is a fixed-point integer whose bit width is 32 bits. The index value of the addition operation result and the reciprocal are both fixed-point integers whose bit width is 8 bits. In other words, the second lookup table is 8-input and 8-output. The multiplication operation result is a fixed-point integer whose bit width is 16 bits. The result obtained by converting the multiplication operation result is a fixed-point integer whose bit width is 8 bits. That is to say, N0, N1, N3, N4, and N6 are 8, N2 is 32, and N5 is 16.

It can be understood that, in some other embodiments, N0 to N6 may be other values. For example, a value range of N0, N1, N3, and N4 may be [8, 32] In some specific examples, the value range may be [8, 12]. For example, N0, N1, N3, N4, and N6 may alternatively be not equal. For example, values of N0 and N3 may be 9, 10, 11, or 12, and N1 and N4 are 8. Because a dynamic range of Softmax function values is very wide, the function is mostly implemented using a software module in the related technology. This embodiment of this application provides the solution basically based on an 8-bit hardware circuit and can effectively balance important indicators of the circuit such as costs, power consumption, bandwidth, performance, and data precision.

In this embodiment, in the procedure of obtaining the reciprocal of the addition operation result of the exponential function values of the data elements in the table lookup manner, the index value conversion parameter is determined based on the addition operation result, the addition operation result is converted, based on the index value conversion parameter, to the corresponding index value, the selected second lookup table is determined from the plurality of candidate second lookup tables, and then the reciprocal corresponding to the index value of the addition operation result is output according to the index value of an addition operation result and based on the selected second lookup table. Because the index value conversion parameter is determined in real time according to an addition operation result on which table lookup needs to be performed each time, reliability of the obtained table lookup result can be ensured.

Further, by setting a Softmax function calculation procedure to processing of integer data, and configuring bit widths of input/output data of two times of table lookup into a small range, storage resources occupied by the first lookup table and the second lookup table and the area of the lookup table circuit can be reduced, and the occupied bandwidth can be reduced. In another aspect, the table lookup speed and the fixed-point operation speed can be increased in a precision-allowed range, thereby further increasing the response speed of the circuit and reducing power consumption.

In an embodiment, the index value conversion parameter includes an index value truncation parameter, and the first conversion circuit 15 intercepts, based on the index value truncation parameter, the index value of the addition operation result from a corresponding position in the addition operation result.

In an embodiment, the index value conversion parameter obtaining circuit 14 includes a leading zero count (Leading Zero Count, LZC) circuit. The leading zero count circuit outputs a leading zero count in the addition operation result to the first conversion circuit 15. The leading zero count is a quantity of 0s appearing during scanning starting from the most significant bit of binary data to the first 1.

In another embodiment, the index value conversion parameter obtaining circuit 14 includes a leading 1 detection circuit, and the leading 1 detection circuit is configured to output position data of leading 1 in the addition operation result to the first conversion circuit 15. The leading 1 is the first 1 scanned starting from the most significant bit of the binary data. The leading zero count or the position data of the leading 1 may be used as the index value truncation parameter.

In an embodiment, the first conversion circuit 15 may include a first shifter. In a specific implementation, the first shifter uses the leading zero count as a shifting quantity, and shifts the addition operation result to the left by the shifting quantity, to output shifted data whose bit width is N3 bits, that is, captures data of N3 consecutive bits from the addition operation result in a direction starting from the leading 1 to the least significant, to serve as an index value of the addition operation result. It may be understood that, the first conversion circuit may be specifically configured according to a specific data structure of an index value.

The second conversion circuit 16 is configured to convert the multiplication operation result from data whose bit width is N5 bits to data whose bit width is N6 bits. In a specific implementation, the second conversion circuit 16 includes a second shifter. It may be understood that, depending on actual needs, the second conversion circuit 16 may perform processing such as saturation (saturate) or integer conversion, to enable a data conversion result of the second conversion circuit 16 to correspond to a data conversion result of the first conversion circuit 15. The integer conversion includes, for example, rounding (round), ceiling, flooring, and rounding to zero.

In an embodiment, the storage module 10 includes a static storage module. In a specific implementation, the static storage module is a ROM, and a plurality of candidate second lookup tables are written into the static storage module by a compiler. In another specific implementation, the static storage module is a SRAM, and a plurality of candidate second lookup tables are loaded into the SRAM after the circuit is powered on. After the index value conversion parameter obtaining circuit 14 outputs the index value conversion parameter, the lookup table circuit 11 outputs, based on the selected second lookup table, the reciprocal corresponding to the index value of the addition operation result.

The plurality of candidate second lookup tables respectively correspond to different index value conversion parameters. Taking an example in which the index value conversion parameter is the leading zero count, for the addition operation result whose bit width is 32 bits, a minimum possible value of the leading zero count is 0 (in other words, a most significant bit of the addition operation result is 1), and a maximum possible value of the leading zero count is 31 (in other words, a least significant bit of the addition operation result is 1, and other preceding bits are all 0). In other words, the leading zero count may be any integer value in [0, 31], and there are a total of 32 possibilities. Different index value conversion parameters represent value ranges of different addition operation results, and therefore value ranges of reciprocals of the addition operation results are also different. Therefore, corresponding to 32 possible index value conversion parameters, the quantity of candidate second lookup tables is also 32. A corresponding second lookup table may be selected according to a specific value of the leading zero count.

In another embodiment, the storage module 10 includes a dynamic storage module. The dynamic storage module may be, for example, a DRAM, and is configured to store the selected second lookup table selectively written corresponding to the index value conversion parameter. The plurality of candidate second lookup tables may be stored in another memory, and may be written into, for example, a ROM by a compiler. After the index value conversion parameter obtaining circuit 14 outputs the index value conversion parameter, the selected second lookup table is loaded into the dynamic storage module connected to the lookup table circuit 11. The lookup table circuit 11 outputs, based on the selected second lookup table stored in the dynamic storage module, the reciprocal corresponding to the addition operation result.

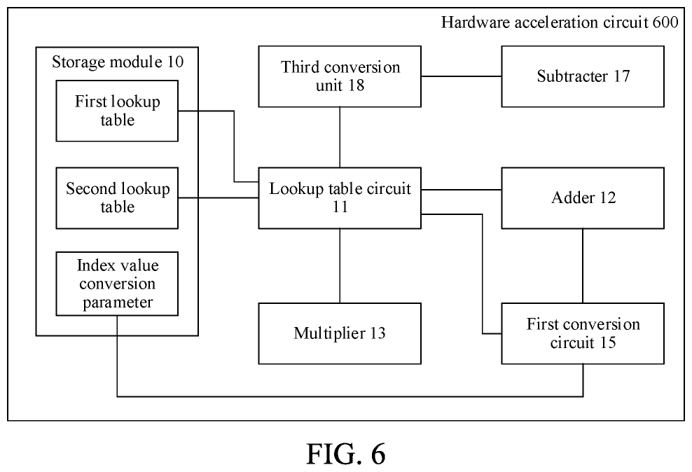

FIG. 6 is a structural block diagram of a hardware acceleration circuit according to another embodiment of this application.

Referring to FIG. 6, a hardware acceleration circuit 600 includes a storage module 10, a lookup table circuit 11, an adder 12, a multiplier 13, a first conversion circuit 15, a subtracter 17, and a third conversion unit 18.

The subtracter 17 is configured to output a subtraction operation result of each of a plurality of pieces of initial data in an initial data set and a maximum value in the plurality of pieces of initial data, to obtain a data set including a plurality of data elements.

Through the foregoing subtraction operation, a value range of the data elements can be reduced, thereby making it convenient to implement the solution of this application using data with a smaller bit width and a corresponding hardware circuit. In another aspect, because the values of the data elements in the data set are negative values or 0, exponential function values of the data elements using e as the base may be normalized into a range of (0, 1].

The third conversion unit 18 is configured to convert the data elements in the data set to index values in the first lookup table.

To better understand a lookup procedure of this embodiment, Table 1 shows a specific example of the first lookup table, and the table is N0 input and N1 output, where N0 and N1 are both 8. A data element of the first lookup table is an index value whose bit width is N0 bits, and output data is an exponential function value whose bit width is N1 bits. For ease of understanding, each data in Table 1 is represented in a decimal format. It may be understood that, the first lookup table in the storage module 10 stores only a true value of the exponential function value, and the lookup table circuit is configured to implement a mapping relationship between the index value and the true value of the exponential function value. To better understand this application, data elements and normalized exponential function value are listed in a table together.

TABLE 1

| | | Normalized | Exponential |
|---|---|---|---|
| | Data | exponential function | function |
| Index value | element | value | value |
| 0 | 0 | 1.0 | 255 |
| 1 | −0.0390625 | 0.96169 | 246 |
| 2 | −0.078125 | 0.92485 | 237 |
| . . . | . . . | . . . | . . . |
| 254 | −0.960784 | 0.000047 | 0 |
| 255 | −10 | 0.000045 | 0 |

As shown in Table 1, data elements output by the subtracter 17 are negative values or 0, and a value range of the data elements is defined as [−10, 0]. To perform table lookup, the value range [−10, 0] is discretized into 256 (namely, 2^{N0}) points shown by the column “data element”, an exponential function value of corresponding to each point is shown by the column “normalized exponential function value”, each data element point corresponds to an integer value in the range of [0, 255] shown in the column “index value”, each normalized exponential function value corresponds to an integer value in the range of [0, 255] shown in the column “exponential function value”, data in the column “exponential function value” is used as a true value and stored in the storage module 10, and table lookup may be implemented through only an index value.

The storage module 10 may include a static storage module. The first lookup table and the second lookup table are stored in different storage units of the static storage module, and the static storage module further stores an index value conversion parameter; and the first lookup table, the second lookup table, and the index value conversion parameter may be written into the static storage module, for example, by a compiler.

In an embodiment, the index value conversion parameter may be determined in an offline manner, and then written into the static storage module by the compiler. The first conversion circuit 15 may obtain the index value of the addition operation result directly according to the index value conversion parameter written into the static storage module. The index value conversion parameter may be determined, by collecting statistics on Gaussian distribution data of a plurality of addition operation results of a plurality of sample data sets, according to the Gaussian distribution data. In a specific implementation, a plurality of sample data sets may be obtained; a plurality of exponential function values corresponding to a plurality of sample data elements for each sample data set are obtained through the lookup table circuit 11, and an addition operation result of the plurality of exponential function values is obtained through the adder 12, where the addition operation result is data whose bit width is N2 bits; and then statistics are collected on Gaussian distribution data of a plurality of addition operation results of the plurality of sample data sets, and N3 bits whose values are distributed maximally in the plurality of addition operation results are determined according to the Gaussian distribution data, where position data corresponding to the N3 bits (for example, a start bit and/or an end bit of the N3 bits) is used as an index value truncation parameter. The first conversion circuit 15 may intercept, according to the index value truncation parameter written into the static storage module in advance, data of N3 consecutive bits from the addition operation result output by the adder (for example, if the addition operation result of 32 bits is 00000000_00000000_00000001_11000001, and the index value truncation parameter is [23, 30], the intercepted data is 8 bits from the 23^{rd} bit to the 30^{th} bit in a direction from the most significant bit to the least significant bit: 11100000), where the intercepted data is used as the index value of the addition operation result.

The lookup table circuit 11 is configured to output, in response to respective index values of the plurality of data elements in the data set and based on the first lookup table, the plurality of exponential function values corresponding to the plurality of data elements.

The adder 12 is configured to output the addition operation result to the lookup table circuit 11, where the addition operation result is a result obtained by performing an addition operation on the plurality of exponential function values.

The first conversion circuit 15 is configured to convert, based on the index value conversion parameter stored in the storage module 10, the addition operation result to an index value whose bit width is N3 bits, namely, an index value in the second lookup table.

The lookup table circuit 11 is further configured to output, in response to the N3-bit index value of the addition operation result and based on the second lookup table, a reciprocal corresponding to the addition operation result.

The second lookup table corresponds to the index value conversion parameter. After the index value conversion parameter is determined in the foregoing offline manner, the second lookup table corresponding to the index value conversion parameter may be determined, and then the second lookup table may be written into the storage module 10 through a compiler, or loaded into the storage module 10 after the circuit is powered on.

The multiplier 13 is configured to output a multiplication operation result of an exponential function value of an i^{th} data element in the plurality of data elements and the reciprocal of the addition operation result, to obtain a Softmax function value of the i^{th} data element.

In this embodiment, the index value conversion parameter is determined in advance in the offline manner, the addition operation result is converted, based on the index value conversion parameter, to the corresponding index value, and then the reciprocal corresponding to the index value of the addition operation result is output according to the index value of an addition operation result and based on the second lookup table. The index value conversion parameter is determined in advance, to avoid procedures of determining the index value conversion parameter and determining the selected second lookup table from the plurality of candidate second lookup tables according to the index value conversion parameter, and it is unnecessary to store all the candidate the second lookup tables. Therefore, the data processing amount can be reduced, the response speed of the circuit can be increased, and required hardware resources and power consumption can be reduced.

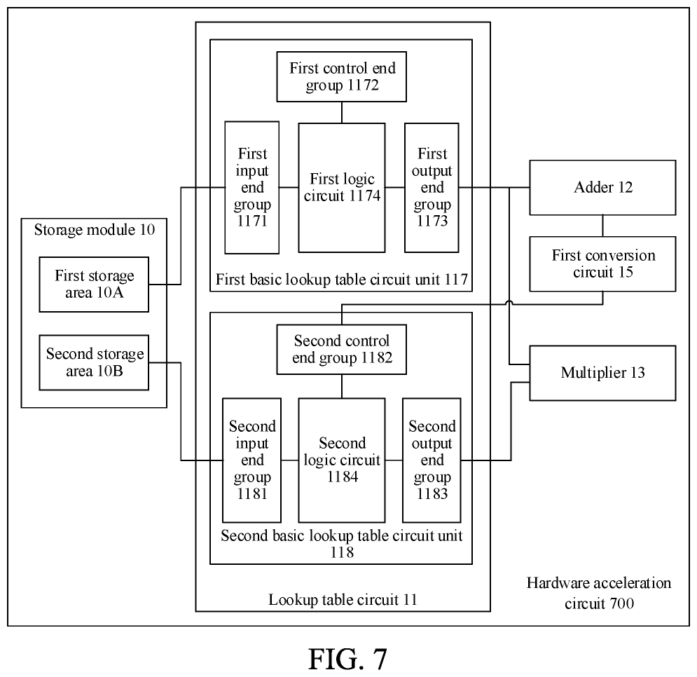

FIG. 7 is a structural block diagram of a hardware acceleration circuit according to another embodiment of this application.

Referring to FIG. 7, a hardware acceleration circuit 700 includes a storage module 10, a lookup table circuit 11, an adder 12, a multiplier 13, and a first conversion circuit 15.

The storage module 10 includes a first storage area 10A and a second storage area 10B, the first lookup table is stored in the first storage area 10A, and the second lookup table is stored in the second storage area 10B.

The lookup table circuit 11 includes a first basic lookup table circuit unit 117 and a second basic lookup table circuit unit 118.

The first basic lookup table circuit unit 117 includes a first input end group 1171, a first control end group 1172, a first output end group 1173, and a first logic circuit 1174, and the first input end group 1171 is connected to the first storage area 10A. The first logic circuit 1174 is configured to: output, in response to an index value of a data element input from the first control end group 1172, a corresponding exponential function value stored in the first storage area 10A from the first output end group 1173.

The second basic lookup table circuit unit 118 includes a second input end group 1181, a second control end group 1182, a second output end group 1183, and a second logic circuit 1184, and the second input end group 1181 is connected to the second storage area 10B. The second logic circuit 1184 is configured to: output, in response to an index value of an addition operation result input from the second control end group 1182, a corresponding reciprocal stored in the second storage area 10B from the second output end group 1183. The first basic lookup table circuit unit is N0 input and N1 output, and the second basic lookup table circuit unit is N3 input and N4 output, where a value range of N0 to N4 is [8, 32]. In some specific examples, the value range may be [8, 12].

In an embodiment, the first control end group 1172 sequentially inputs index values of a plurality of data elements in a data set to the first logic circuit 1174; and the first logic circuit 1174 outputs, in response to the index values, corresponding exponential function values from the first output end group 1173.

The adder 12 performs an addition operation on the plurality of exponential function values corresponding to the plurality of data elements output by the first output end group 1173, to obtain an addition operation result of the plurality of exponential function values.

The first conversion circuit 15 is configured to convert the addition operation result to a corresponding index value.

The second control end group 1182 inputs the index value of addition operation result to the second basic lookup table circuit unit 118; and the second logic circuit 1184 outputs, in response to the index value of the addition operation result input from the second control end group 1182, a corresponding reciprocal from the second output end group 1183.

The multiplier 13 performs a multiplication operation on an exponential function value corresponding to an i^{th} data element output by the first output end group 1173, and the reciprocal corresponding to the addition operation result output by the second output end group 1183, to obtain a multiplication operation result, where the obtained multiplication operation result is used as a Softmax function value corresponding to the i^{th} data element.

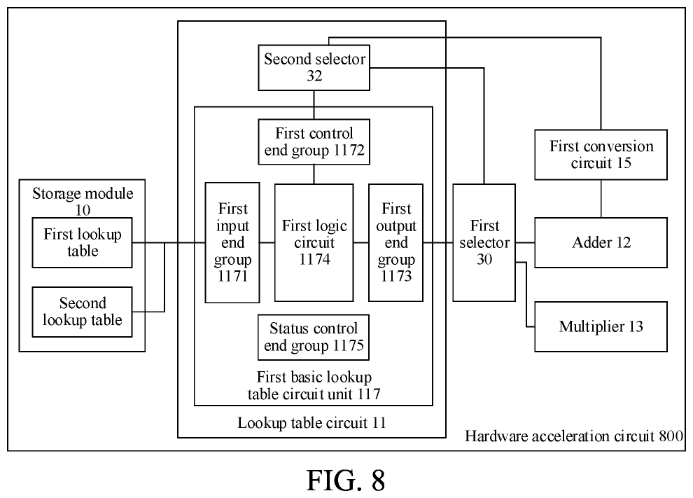

FIG. 8 is a structural block diagram of a hardware acceleration circuit according to another embodiment of this application.

Referring to FIG. 8, a hardware acceleration circuit 800 includes a storage module 10, a lookup table circuit 11, an adder 12, a multiplier 13, and a first conversion circuit 15.

This embodiment and the hardware acceleration circuit 400 shown in FIG. 5 are similar, and a difference is as follows:

The lookup table circuit 11 includes a first basic lookup table circuit unit 117.

The first basic lookup table circuit unit 117 includes a first input end group 1171, a first control end group 1172, a first output end group 1173, and a first logic circuit 1174, and the first input end group 1171 is connected to the storage module 10. The first logic circuit is configured to: output, in response to an index value of the i^{th} data element input from the first input end group 1171 and based on the first lookup table, the exponential function value corresponding to the i^{th} data element from the first output end group 1173 in a first period of time, and output, in response to the index value of the addition operation result input from the first input end group 1171 and based on the second lookup table, the reciprocal corresponding to the addition operation result from the first output end group 1173 in a second period of time after the first period of time.

In a specific implementation, the storage module 10 includes a first storage area, and the first lookup table and the second lookup table are stored in the first storage area in a time-sharing manner. Because only one storage area needs to be configured to store either of the first lookup table and the second lookup table in a time-sharing manner, a storage space occupied by the lookup tables is effectively reduced, and hardware costs can be reduced.

In another specific implementation, the storage module 10 includes a first storage area and a second storage area, the first lookup table is stored in the first storage area, and the second lookup table is stored in the second storage area.

In a specific implementation, N3 and N0 are equal, and N4 and N1 are equal. In other words, the first lookup table and the second lookup table are both N0-input and N1-output. Correspondingly, the first basic lookup table circuit unit 117 is fixedly in an N0-input and N1-output status. In another specific implementation, the first lookup table is N0-input and N1-output, and the second lookup table is N3-input and N4-output, where N3 and N0 are not equal, and/or N4 and N1 are not equal. In other words, at least one of a pair of N0 and N3 and a pair of N1 and N4 is not equal. The first basic lookup table circuit unit 117 further includes a status control end group 1175, configured to input a first status control signal in the first period of time and input a second status control signal in the second period of time, to configure the first basic lookup table circuit unit 117 into an N0-input and N1-output status in the first period of time and an N2-input and N3-output status in the second period of time.

It may be understood that, in this embodiment, a first selector 30 and a second selector 32 are further included. The first selector 30 is configured to output the exponential function values corresponding to the data elements output by the first output end group 1173 to the adder 12, and output the reciprocal corresponding to the addition operation result output by the first output end group 1173 to the second selector 32. The second selector 32 is configured to selectively input the index values of the data elements or the index value of the addition operation result output by the first conversion circuit 15 to the first logic circuit 1174.

In this embodiment, by reusing the basic lookup table circuit unit, it is necessary to configure only one basic lookup table circuit unit, so that the area and costs of the lookup table circuit can be effectively reduced.

This application further provides an embodiment of a data processing acceleration method.

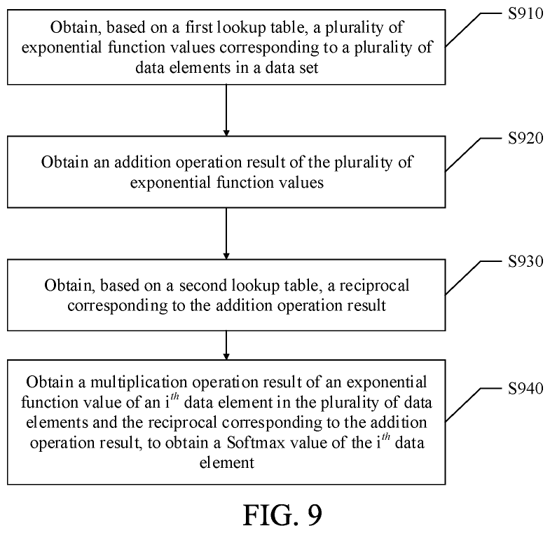

FIG. 9 is a schematic flowchart of a data processing acceleration method according to an embodiment of this application.

Referring to FIG. 9, the data processing acceleration method includes:

In step S910, a plurality of exponential function values corresponding to a plurality of data elements in a data set are obtained based on a first lookup table.

In step S920, an addition operation result of the plurality of exponential function values is obtained.

In step S930, a reciprocal corresponding to the addition operation result is obtained based on a second lookup table.

In step S940, a multiplication operation result of an exponential function value of an i^{th} data element in the plurality of data elements and the reciprocal corresponding to the addition operation result is obtained, to obtain a Softmax function value of the i^{th} data element.

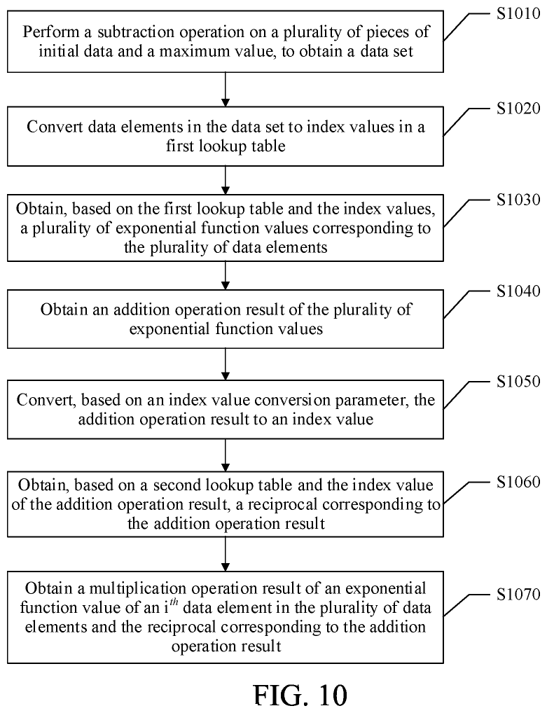

FIG. 10 is a schematic flowchart of a data processing acceleration method according to another embodiment of this application.

Referring to FIG. 10, the data processing acceleration method of this embodiment includes:

In step S1010, a subtraction operation is performed on a plurality of pieces of initial data and a maximum value, to obtain a data set.

A maximum value of a plurality of pieces of initial data in an initial data set may be obtained through a subtracter, and a subtraction operation is performed on the plurality of pieces of initial data and the maximum value, to obtain a data set including a plurality of data elements.

Through the foregoing subtraction operation, because a value of each data element in the data set is a negative value or 0, exponential function values of the data elements using e as the base may be normalized into a range of (0, 1].

In step S1020, data elements in the data set is converted to index values in a first lookup table.

The data elements in the data set may be converted to the index values in the first lookup table through the third conversion unit.

Through conversion, the data elements may be converted from negative values or 0 to the index values in the first lookup table, and the index values are fixed-point integers whose bit widths are N0 bits.

In step S1030, a plurality of exponential function values corresponding to the plurality of data elements are obtained based on the first lookup table and the index values.

The plurality of exponential function values corresponding to the plurality of data elements in the data set may be obtained based on the first lookup table and the index values through a lookup table module.

It may be understood that, table lookup procedures of the plurality of data elements may be parallel procedures, namely, the lookup table module is a multi-input and multi-output module, the index values of the plurality of data elements are input to the lookup table module in parallel, and the lookup table module outputs the plurality of corresponding exponential function values in parallel; or table lookup procedures of the plurality of data elements may be serial procedures, namely, the index values of the plurality of data elements are input to the lookup table module sequentially, and the lookup table module outputs an exponential function value of each data element sequentially.

Through table lookup, the exponential function values corresponding to the data elements may be obtained, and the exponential function values may be fixed-point integers whose bit widths are N1 bits.

In step S1040, an addition operation result of the plurality of exponential function values is obtained.

The addition operation result of the plurality of exponential function values may be obtained through an adder. The addition operation result output by the adder is a fixed-point integer whose bit width is N2 bits.

In step S1050, the addition operation result is converted, based on an index value conversion parameter, to an index value.

The addition operation result may be converted from data whose bit width is N2 bits to an index value whose bit width is N3 bits, namely, an index value in a second lookup table based on the preset index value conversion parameter through a first conversion circuit, where N3 is less than N2.

In this embodiment, the index value conversion parameter may be determined in an offline manner.

In a specific implementation, a plurality of sample data sets may be obtained; a plurality of exponential function values corresponding to a plurality of sample data elements for each sample data set are obtained through the lookup table circuit, and an addition operation result of the plurality of exponential function values is obtained through the adder, where the addition operation result is data whose bit width is N2 bits; and then statistics are collected on Gaussian distribution data of a plurality of addition operation results of the plurality of sample data sets, and N3 bits whose values are distributed maximally in the plurality of addition operation results are determined according to the Gaussian distribution data, where position data corresponding to the N3 bits (for example, a start bit and/or an end bit of the N3 bits) is used as an index value truncation parameter. The first conversion circuit 15 may intercept, according to the index value truncation parameter written into the static storage module in advance, data of N3 consecutive bits from the addition operation result output by the adder (for example, if the addition operation result of 32 bits is 00000000_00000000_00000001_11000001, and the index value truncation parameter is [23, 30], the intercepted data is 8 bits from the 23rd bit to the 30th bit in a direction from the most significant bit to the least significant bit: 11100000), where the intercepted data is used as the index value of the addition operation result.

The second lookup table corresponds to the index value conversion parameter. After the index value conversion parameter is determined in the foregoing offline manner, the second lookup table corresponding to the index value conversion parameter may be determined.

The second lookup table may be written into a ROM through a compiler, or the second lookup table may be loaded into a RAM after the circuit is powered on.

In step S1060, a reciprocal corresponding to the addition operation result is obtained based on the second lookup table and the index value of the addition operation result.

The reciprocal corresponding to the addition operation result may be obtained based on the second lookup table and the index value of the addition operation result through the lookup table module.

The reciprocal corresponding to the addition operation result of the plurality of exponential function values may be obtained through table lookup, where the reciprocal may be a fixed-point integer whose bit width is N4 bits.

In step S1070, a multiplication operation result of an exponential function value of an i^{th} data element in the plurality of data elements and the reciprocal corresponding to the addition operation result is obtained.

The multiplication operation result of the exponential function value of the i^{th} data element in the plurality of data elements and the reciprocal corresponding to the addition operation result may be obtained through a multiplier. The multiplication operation result may be a fixed-point integer whose bit width is N5 bits.

In some embodiments, after the multiplication operation result is obtained, the multiplication operation result is converted from data whose bit width is N5 bits to data whose bit width is N6 bits based on the index value conversion parameter through a second conversion circuit, where N5 is greater than N6.

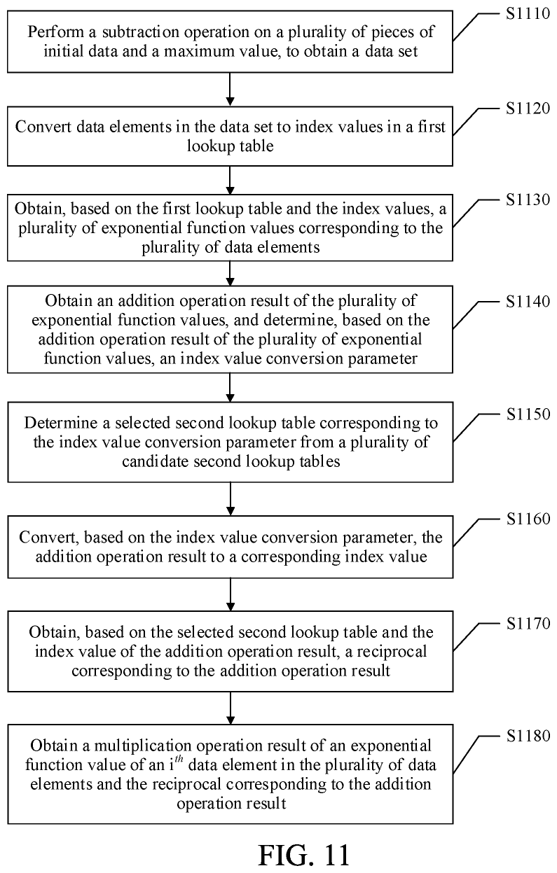

FIG. 11 is a schematic flowchart of a data processing acceleration method according to another embodiment of this application.

Referring to FIG. 11, the data processing acceleration method of this embodiment includes:

In step S1110, a subtraction operation is performed on a plurality of pieces of initial data and a maximum value, to obtain a data set.

A maximum value of a plurality of pieces of initial data in an initial data set may be obtained through a subtracter, and a subtraction operation is performed on the plurality of pieces of initial data and the maximum value, to obtain a data set including a plurality of data elements.

In step S1120, data elements in the data set is converted to index values in a first lookup table.

The data elements in the data set may be converted to the index values in the first lookup table through the third conversion unit.

In step S1130, a plurality of exponential function values corresponding to the plurality of data elements are obtained based on the first lookup table and the index values.

The plurality of exponential function values corresponding to the plurality of data elements in the data set may be obtained based on the first lookup table and the index values through a lookup table module.

In this embodiment, the exponential function values of the data elements using e as the base are obtained in a table lookup manner. It may be understood that, table lookup procedures of the data elements may be parallel procedures, namely, the lookup table module is a multi-input and multi-output module, the index values of the plurality of data elements are input to the lookup table module in parallel, and the lookup table module outputs the plurality of corresponding exponential function values in parallel; or table lookup procedures of the plurality of data elements may be serial procedures, namely, the index values of the plurality of data elements are input to the lookup table module sequentially, and the lookup table module outputs an exponential function value of each data element sequentially.

In step S1140, an addition operation result of the plurality of exponential function values is obtained, and an index value conversion parameter is determined based on the addition operation result of the plurality of exponential function values.

The addition operation result of the plurality of exponential function values may be obtained through an adder, and the index value conversion parameter is determined based on the addition operation result of the plurality of exponential function values.

In step S1150, a selected second lookup table corresponding to the index value conversion parameter is determined from a plurality of candidate second lookup tables.

The selected second lookup table corresponding to the index value conversion parameter may be determined from the plurality of candidate second lookup tables through a second lookup table determining module.

In a specific implementation, the plurality of candidate second lookup tables are written into a static storage module through a compiler, and after the selected second lookup table is determined, the selected second lookup table may be loaded into a dynamic storage module.

In step S1160, the addition operation result is converted, based on the index value conversion parameter, to a corresponding index value.

The addition operation result may be converted, based on the index value conversion parameter, to the corresponding index value through a first conversion circuit.

In step S1170, a reciprocal corresponding to the addition operation result is obtained based on the selected second lookup table and the index value of the addition operation result.

The reciprocal corresponding to the addition operation result may be obtained based on the selected second lookup table and the index value of the addition operation result through the lookup table module.

In step S1180, a multiplication operation result of an exponential function value of an i^{th} data element in the plurality of data elements and the reciprocal corresponding to the addition operation result is obtained.

The multiplication operation result of the exponential function value of the i^{th} data element in the plurality of data elements and the reciprocal corresponding to the addition operation result may be obtained through a multiplier.

For related features of the data processing acceleration method in this embodiment of this application, reference may be made to related content in the embodiment of the foregoing hardware acceleration circuit. Details are not described again.

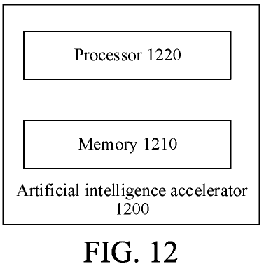

The data processing acceleration method according to this embodiment of this application may be applied to an artificial intelligence accelerator. FIG. 12 is a schematic structural diagram of an artificial intelligence accelerator according to an embodiment of this application. Referring to FIG. 12, the artificial intelligence accelerator 1200 includes a memory 1210 and a processor 1220.

The processor 1220 of the artificial intelligence accelerator 1200 may be a general-purpose processor such as a CPU (Central Processing Unit, central processing unit), or may be an intelligence processing unit (IPU) configured to execute an artificial intelligence operation. The artificial intelligence operation may include a machine learning operation, a brain-like operation, and the like. The machine learning operation includes a neural network operation, a k-means operation, a support vector machine operation, and the like. The intelligence processing unit may include, for example, one of a GPU (Graphics Processing Unit, graphics processing unit), a DLA (Deep Learning Accelerator, deep learning accelerator), an NPU (Neural-Network Processing Unit, neural network processing unit), a DSP (Digital Signal Processor, digital signal processor), a field-programmable gate array (Field-Programmable Gate Array, FPGA), and an application-specific integrated circuit (Application-Specific Integrated Circuit, ASIC) or a combination thereof. A specific type of the processor is not limited in this application.

The memory 1210 may include various types of storage units, for example, a system memory, a read-only memory (ROM), and a permanent storage apparatus. The ROM may store static data or instruction required by the processor 1220 or another module of a computer. The permanent storage apparatus may be a readable/writable storage apparatus. The permanent storage apparatus may be a non-volatile storage device that does not lose stored instructions and data even if the computer is powered off. In some implementations, a mass storage apparatus (for example, a magnetic disk, an optical disc, or a flash memory) is used as the permanent storage apparatus. In some other implementations, the permanent storage apparatus may be a removable storage device (for example, a floppy disk or an optical disc drive). The system memory may be a readable/writable storage device or a volatile readable/writable storage device, for example, a dynamic random access memory. The system memory may store some or all instructions and data required by the processor during running. Moreover, the memory 1210 may include any combination of computer-readable storage mediums, including various types of semiconductor storage chips (for example, a DRAM, an SRAM, an SDRAM, a flash memory, and a programmable read-only memory), and a magnetic disk and/or an optical disc may alternatively be used as the memory. In some implementations, the memory 1210 may include a readable and/or writable removable storage device, for example, a compact disc (CD), a read-only digital versatile disc (for example, a DVD-ROM or a double-layer DVD-ROM), a read-only Blu-ray disc, an ultra-density optical disc, a flash memory card (for example, an SD card, a min SD card, or a Micro-SD card), a magnetic floppy disk, and the like. The computer-readable storage medium does not include a carrier and an instantaneous electronic signal transmitted in a wireless or wired manner.

Executable code is stored on the memory 1210. When the executable code is processed by the processor 1220, the processor 1220 is enabled to execute part or all of the foregoing method.

In a possible implementation, the artificial intelligence accelerator may include a plurality of processors, and various assigned tasks may be independently run on each processor. The processor and the tasks run on the processor are not limited in this application.

It may be understood that, unless otherwise specified, functional units/modules in the embodiments of this application may be integrated into one unit/module, or each unit/module may exist alone physically, or two or more units/modules are integrated together. The foregoing integrated unit/module may be implemented in a form of hardware, or may be implemented in a form of a software program module.

If the integrated unit/module is implemented in a form of hardware, the hardware may be a digital circuit, an analog circuit, or the like. A physical implementation of the hardware structure includes but is not limited to a transistor, a memristor, or the like. Unless otherwise specified, the intelligence processing unit may be any proper hardware processor, for example, a CPU, a GPU, an FPGA, a DSP, or an ASIC. Unless otherwise specified, the storage module may be any proper magnetic disk storage medium or magnetic disk optical storage medium, for example, a resistive memory RRAM (Resistive Random Access Memory), a dynamic random access memory DRAM (Dynamic Random Access Memory), a static random access memory SRAM (Static Random Access Memory), an enhanced dynamic random access memory EDRAM (Enhanced Dynamic Random Access Memory), a high-bandwidth memory HBM (High-Bandwidth Memory), or a hybrid memory cube HMC (Hybrid Memory Cube).

When the integrated unit/module is implemented in the form of a software program module and sold or used as an independent product, the integrated module may be stored in a computer-readable memory. Based on such an understanding, the technical solutions of this application essentially, or the part contributing to the prior art, or all or some of the technical solutions may be implemented in a form of a software product. The computer software product is stored in a memory, and includes several instructions for instructing a computer device (which may be a personal computer, a server, or a network device) to perform all or some of the steps of the methods described in the embodiments of this application. The foregoing memory includes any medium that can store program code, such as a USB flash drive, a read-only memory (ROM, Read-Only Memory), a random access memory (RAM, Random Access Memory), a removable hard disk, a magnetic disk, or an optical disc.

In a possible implementation, an artificial intelligence chip is further disclosed, including the foregoing hardware acceleration circuit.

In a possible implementation, a card is further disclosed, including a storage device, an interface apparatus, a control device, and the foregoing artificial intelligence chip. The artificial intelligence chip is connected to each of the storage device, the control device, and the interface apparatus; the storage device is configured to store data; the interface apparatus is configured to implement data transmission between the artificial intelligence chip and an external device; and the control device is configured to monitor a status of the artificial intelligence chip.

In a possible implementation, an electronic device is disclosed, including the foregoing artificial intelligence chip. The electronic device includes a data processing apparatus, a robot, a computer, a printer, a scanner, a tablet computer, an intelligent terminal, a mobile phone, an event data recorder, a navigator, a sensor, a webcam, a server, a cloud server, a camera, a video camera, a projector, a watch, a headset, a portable storage, a wearable device, a transportation means, a household appliance, and/or a medical device. The transportation means includes an airplane, a steamship, and/or a vehicle; the household appliance includes a television set, an air conditioner, a microwave stove, a refrigerator, an electric cooker, a humidifier, a washing machine, an electric lamp, a gas stove, and a range hood; and the medical device includes a nuclear magnetic resonance spectrometer, a B-mode ultrasonic instrument, and/or an electrocardiogramachine.

Moreover, the method according to this application may be further implemented as a computer program or computer program product, and the computer program or computer program product includes computer program code instructions used to execute some or all steps in the foregoing method of this application.

Alternatively, this application may be further implemented as a computer-readable storage medium (or a non-transient machine-readable storage medium or a machine-readable storage medium), on which executable code (or computer program or computer instruction code) is stored. When the executable code (or computer program or computer instruction code) is executed by a processor of an electronic device (or server or the like), the processor is enabled to execute some or all of the steps of the foregoing method according to this application.

The embodiments of this application are described above, and the foregoing descriptions are exemplary but not exhaustive and are not limited to the disclosed embodiments. Without departing from the scope and spirit of the described embodiments, many modifications and variations are apparent to a person of ordinary skill in the technical field. The selected terms used herein is intended to best explain the principles of the embodiments, practical applications, or improvements of technologies in the market, or to enable other persons of ordinary skill in the technical field to understand the embodiments disclosed herein.

What is claimed is:

1. A hardware acceleration circuit, comprising:
a storage module, configured to store a first lookup table and a second lookup table;
a lookup table circuit, configured to output, in response to respective index values of a plurality of data elements in a data set and based on the first lookup table, a plurality of exponential function values corresponding to the plurality of data elements; and output, in response to an index value of an addition operation result and based on the second lookup table, a reciprocal corresponding to the addition operation result;
an adder, configured to output the addition operation result to the lookup table circuit, wherein the addition operation result is a result obtained by performing an addition operation on the plurality of exponential function values; and
a multiplier, configured to output a multiplication operation result of an exponential function value of an i^{th} data element in the plurality of data elements and the reciprocal, to obtain a Softmax function value of the i^{th} data element.

2. The hardware acceleration circuit according to claim 1, wherein
the exponential function value is data whose bit width is N1 bits, the addition operation result is data whose bit width is N2 bits, and an index value of the addition operation result is data whose bit width is N3 bits, wherein, N1 and N3 are less than N2; and
the hardware acceleration circuit further comprises: a first conversion circuit, configured to convert, based on an index value conversion parameter, the addition operation result to the index value of the addition operation result.

3. The hardware acceleration circuit according to claim 2, wherein
the storage module comprises a static storage module;
the index value conversion parameter is stored in the static storage module; and
the index value conversion parameter is determined, by collecting statistics on Gaussian distribution data of a plurality of addition operation results of a plurality of sample data sets, according to the Gaussian distribution data.

4. The hardware acceleration circuit according to claim 2, further comprising:
an index value conversion parameter obtaining circuit, configured to determine and output, based on the addition operation result, the index value conversion parameter, wherein
the first conversion circuit is configured to convert, based on the index value conversion parameter, the addition operation result to the corresponding index value; and
the outputting, by the lookup table circuit based on the second lookup table, a reciprocal corresponding to the addition operation result is specifically: outputting, based on a selected second lookup table, the reciprocal corresponding to the addition operation result, wherein the second lookup table is a second lookup table that corresponds to the index value conversion parameter and that is of a plurality of candidate second lookup tables.

5. The hardware acceleration circuit according to claim 4, wherein
the storage module comprises a static storage module, and the plurality of candidate second lookup tables are stored in the static storage module; or
the storage module comprises a dynamic storage module, and the selected second lookup table is stored in the dynamic storage module.

6. The hardware acceleration circuit according to claim 1, wherein
the storage module comprises a first storage area and a second storage area, the first lookup table is stored in the first storage area, and the second lookup table is stored in the second storage area;
the lookup table circuit comprises:
a first basic lookup table circuit unit, comprising a first logic circuit, a first input end group, a first control end group, and a first output end group, wherein the first input end group is connected to the first storage area; the first logic circuit is configured to: output, in response to an index value of the i^{th} data element in the data set input from the first control end group, a corresponding exponential function value from the first output end group; and
a second basic lookup table circuit unit, comprising a second logic circuit, a second input end group, a second control end group, and a second output end group, wherein the second input end group is connected to the second storage area; the second logic circuit is configured to: output, in response to the index value of the addition operation result input from the second control end group, the corresponding reciprocal from the second output end group,
wherein the first basic lookup table circuit unit is N0 input and N1 output, and the second basic lookup table circuit unit is N3 input and N4 output, wherein a value range of N0, N1, N3, and N4 is [8, 32].

7. The hardware acceleration circuit according to claim 1, wherein
the storage module comprises a first storage area, configured to store the first lookup table and the second lookup table in a time-sharing manner; or the storage module comprises a first storage area and a second storage area, the first lookup table is stored in the first storage area, and the second lookup table is stored in the second storage area;
the lookup table circuit comprises:
a first basic lookup table circuit unit, comprising a first logic circuit, a first input end group, a first control end group, and a first output end group, wherein the first input end group is connected to the storage module, and the first logic circuit configured to: output, in response to an index value of the i^{th} data element input from the first input end group and based on the first lookup table, the exponential function value corresponding to the i^{th} data element from the first output end group in a first period of time, and output, in response to the index value of the addition operation result input from the first input end group and based on the second lookup table, the reciprocal corresponding to the addition operation result from the first output end group in a second period of time after the first period of time,
wherein the first basic lookup table circuit unit is in an N0-input and N1-output status; or
wherein the first basic lookup table circuit unit further comprises a status control end group, configured to input a first status control signal in the first period of time and input a second status control signal in the second period of time, to configure the basic lookup table circuit unit into an N0-input and N1-output status in the first period of time and an N3-input and N4-output status in the second period of time, at least one of a pair of N0 and N3 and a pair of N1 and N4 is not equal.

8. The hardware acceleration circuit according to claim 2, further comprising:
a second conversion circuit, configured to convert, based on the index value conversion parameter, the multiplication operation result from data whose bit width is N4 bits to a Softmax function value whose bit width is N5 bits, wherein N4 is greater than N5.

9. The hardware acceleration circuit according to claim 2, further comprising:
a subtracter, configured to output subtraction operation results of a plurality of pieces of initial data in an initial data set and a maximum value in the plurality of pieces of initial data, to obtain the data set comprising the plurality of data elements; and
a third conversion unit, configured to convert the plurality of data elements to a plurality of index values corresponding to the first lookup table.

10. The hardware acceleration circuit according to claim 1, wherein
the exponential function value, the addition operation result, the multiplication operation result, and the reciprocal of the addition operation result are fixed-point integers.

11. An artificial intelligence chip, comprising the hardware acceleration circuit according to claim 1.

12. A data processing acceleration method, comprising:
obtaining, based on a first lookup table, a plurality of exponential function values corresponding to a plurality of data elements in a data set;
obtaining an addition operation result of the plurality of exponential function values;
obtaining, based on a second lookup table, a reciprocal corresponding to the addition operation result; and
obtaining a multiplication operation result of an exponential function value of an i^{th} data element in the plurality of data elements and the reciprocal corresponding to the addition operation result, to obtain a Softmax function value of the i^{th} data element.

13. The method according to claim 12, wherein the reciprocal corresponding to the addition operation result is obtained, based on the second lookup table, by:
converting, based on an index value conversion parameter, the addition operation result from data whose bit width is N2 bits to an index value whose bit width is N3 bits, wherein N3 is less than N2; and
obtaining, based on the second lookup table and the index value of the addition operation result, the reciprocal corresponding to the addition operation result.

14. The method according to claim 13, further comprising:
writing the index value conversion parameter into a static storage module through a compiler; and
determining the index value conversion parameter by collecting statistics on Gaussian distribution data of a plurality of addition operation results of a plurality of sample data sets, according to the Gaussian distribution data.

15. The method according to claim 13, further comprising:
determining, based on the addition operation result, the index value conversion parameter;
wherein the reciprocal corresponding to the addition operation result is obtained, based on the second lookup table and the index value of the addition operation result, by:
determining a selected second lookup table corresponding to the index value conversion parameter from a plurality of candidate second lookup tables; and
obtaining, based on the selected second lookup table and the index value of the addition operation result, the reciprocal corresponding to the addition operation result.

16. The method according to claim 15, further comprising:
writing the plurality of candidate second lookup tables into a static storage module through a compiler; and/or
loading the selected second lookup table into a dynamic storage module.

17. The method according to claim 12, wherein
before the obtaining, based on a first lookup table, a plurality of exponential function values corresponding to a plurality of data elements in a data set, the method further comprises: performing a subtraction operation on a plurality of pieces of initial data in an initial data set and a maximum value in the plurality of pieces of initial data, to obtain the data set comprising the plurality of data elements; and/or
after the obtaining a multiplication operation result of an exponential function value of an i^{th} data element in the plurality of data elements and the reciprocal, the method further comprises: converting, based on an index value conversion parameter, the multiplication operation result from data whose bit width is N4 bits to data whose bit width is N5 bits, wherein N4 is greater than N5.

18. The method according to claim 12, wherein
the exponential function value, the addition operation result, the multiplication operation result, and the reciprocal of the addition operation result are fixed-point integers; and
a bit width value range of the exponential function value and the reciprocal is [8, 32].

19. The method according to claim 12, wherein the method is used for implementing a Softmax function layer of a neural network, and the neural network is configured to classify to-be-processed data, wherein
the to-be-processed data comprises at least one of voice data, text data, and image data.

20. An artificial intelligence accelerator, comprising:
a processor; and
a memory, wherein executable code is stored on the memory, and the executable code, when executed by the processor, enables the processor to perform the method according to claim 12.
